(19) United States
(12) Patent Application Publication
(10) Pub. No.: US 2011/0211603 A1
(43) Pub. Date: Sep. 1, 2011

(54) Laser wavelength stabilization

(76) Inventors: Shengzhong Zhang, Arcadia, CA (US); Near Margalit, Westlake Village, CA (US); Mohammad Azadeh, Northridge, CA (US)

(21) Appl. No.: 13/065,686

(22) Filed: Mar. 28, 2011

Related U.S. Application Data
(63) Continuation of application No. 12/009,450, filed on Jan. 18, 2008, now abandoned.

(51) Int. Cl. H01S 3/04

(52) U.S. Cl. 372/34

(57) ABSTRACT

In a coarse wavelength division multiplexing (CWDM) optical transmission system, a distributed feedback (DFB) laser is tuned so that the peak reflection of the grating overlaps with the gain range of the DFB laser. The diffraction grating is tuned so that the peak is positioned on the long wavelength end of the gain spectrum at a selected temperature. The optical transmission system operates in an environment having a wide temperature range (i.e., about −40° C. to about 85° C.). Heat is applied to the laser and as the laser temperature increases, the gain range overtakes the grating peak. When the gain range and the grating peak overlap at increased laser temperature, laser output is improved.

### CROSS-REFERENCE TO RELATED APPLICATIONS

The present application is a continuation of U.S. patent application Ser. No. 12/009,450, filed on Jan. 18, 2008 which in turn claims the benefit under 35 U.S.C. §119 of U.S. provisional patent application No. 60/700,703 filed on Jul. 18, 2005, and PCT application number PCT/US2006/027534 filed on Jul. 18, 2006, the disclosures of which are herewith incorporated by reference in their entirety.

### BACKGROUND

In recent years there has been a rapid increase in demand for data communications capacity. Traditional users of data communications, including business and government computer networks, have formed an expanding market. In addition, new applications such as digital television, digital telephony and consumer use of computer networks have emerged and grown. Responding to and encouraging this growing demand, advances have been made in electronic and optical communications technologies.

Optical communication devices and networks offer important advantages over other communication systems. Among these advantages are high-bandwidth, imperviousness to a electrical noise, and resistance of the transmission media to electrochemical corrosion. The basic elements of an optical communication system are a light source device that can be modulated to produce a modulated optical signal, a receiver device that responds to the modulated optical signal, and a transmission medium. The light source device can be, for example, a solid-state laser diode.

Common wavelengths of operation for such a light source device are, for example, 850, 1300 or 1550 nm. A typical receiver device includes, for example, a PIN-type photodiode or an avalanche photodiode device (APD). Generally, the transmission medium is an optical waveguide, such as, for example, a glass optical fiber.

The unprecedented capacity of optical fiber makes it an ideal medium for the transport of high-bandwidth signals. In order to recoup installation and maintenance costs, however, it is important to optimize installed capacity. In one approach to achieving increased transmission capacity, a fiber cable typically consists of a number of individual fibers. Four, 12, 24, 40 or more fibers are often included in an optical cable. Such an arrangement allows multiple signals to be transmitted in parallel, providing a system that is, in effect, spatially multiplexed.

Effective data capacity can also be increased by time division multiplexing (TDM) and wavelength division multiplexing (WDM), both of which allow the transmission of multiple data signals over a single fiber. In TDM, portions of two or more, signals are chronologically interleaved such that, a portion of a first signal is transmitted during a first time interval and a portion of a second signal is subsequently transmitted during a second time interval. By repeating this process to produce a series of signal portions in subsequent time intervals, transmission of the two or more signals can be achieved.

In WDM, each optical signal is transmitted on a different optical wavelength. This is analogous to, for example, the free space transmission of multiple radio channels on different frequencies. It is well known to separate light into different bands of wavelength (or color) using an optical prism or a plurality of optical filters. Typically in WDM systems, data signals are carried on non-visible wavelengths. These signals are demultiplexed at a receiving device using optical filters. Although the optical signals used in a WDM system may not include visible light, it is common to refer to various carrier wavelengths as “colors.” Accordingly a number of different wavelengths, taken together, is referred to as “a set of colors.” A WDM “channel” is a signal running on a unique wavelength. Each WDM channel on a fiber is substantially independent of the other channels with regard to bit rates and data transmission protocol. Accordingly, a mixture of serial data interface Serial Digital Interface (SDI), High-Definition Serial Digital Interface (HD-SDI), Synchronous Digital Hierarchy/Synchronous Optical NETwork (SDH/SONET), Gigabit Ethernet and Fast Ethernet can easily be used to transport data signals on the same optical fiber using WDM.

There are two types of WDM, dense WDM (DWDM) and coarse WDM (CWDM). In DWDM, incoming optical signals are assigned to specific wavelengths within a designated frequency band, the 1550 nm region. The wavelength spacings are, for example, 0.8 nm or 1.6 nm. The signals are then multiplexed onto one fiber. DWDM enables multiple video, audio, and data channels to be transmitted over one fiber while maintaining system performance and enhancing transport systems.

DWDM is well-suited to demanding applications such as high-volume digital video. DWDM typically uses temperature-stabilized lasers in order to fix the center wavelength and narrowband filters, providing many densely spaced channels. Typical channel spacing for broadcast-class DWDM equipment is 100 GHz corresponding to a channel spacing of approximately 0.8 nm, thereby avoiding the need for wavelength lockers. The wavelengths used are specified in ITU-T Recommendation G.694.1.

CWDM is a method of combining multiple optical signals in the 1550 nm band at a lower density than DWDM. The wavelength spacing in CWDM is typically 10 to 20 nm. The CWDM wavelengths are standardized in ITU-T Recommendation G.694.2. The Recommendation provides optical parameter values for physical layer interfaces of CWDM applications with up to 16 channels. CWDM typically has a lower cost per channel than DWDM. CWDM offers a cost-effective alternative where, for example, a few more channels in a short fiber span is desired. CWDM conventionally uses non-stabilized lasers in combination with broadband filters. CWDM transmitters generally have lower power consumption than DWDM transmitters.

Lasers operate by oscillating a flux of photons within a lasing medium. Energy is added to the lasing medium to promote electrons out of their atomic ground states and into elevated electron states. This addition of energy is referred to as “pumping” the laser. To be effective, this pumping must produce a higher density of electrons in the elevated electron state than in a lower electron state; a condition referred to as “inversion” of the medium. When a first photon passes through an inverted lasing medium, there is a finite probability that it will initiate an electron state transition from a higher energy state to a lower energy state. This electron state transition produces a second photon traveling in the same direction and in phase with the first photon.

The two parallel photons are referred to as “coherent photons” or “coherent light.” The tendency of the first photon to produce additional photons is referred to as “stimulated emission.” The result is an “amplification” or “gain” of the stimulating photon within the lasing medium.

As coherent photons pass through the pumped lasing medium some photons are absorbed by the atoms of the medium. This absorption of photons counteracts the gain of the medium to reduce the overall photon flux. When the gain of the medium is high enough, in comparison to the absorption level of the medium, so that more photons are produced than absorbed, lasing (i.e., amplification of initial photons) begins. The condition at which lasing begins is referred to as a “lasing threshold.”

The probability that a stimulating photon will stimulate an electron transition, and associated emission of a further coherent photon, is related to the distance that the particular photon travels through the lasing medium. In order to increase the effective length of travel of the stimulating photon, the stimulating photon is reflected back and forth (i.e., oscillated) within the lasing medium.

One way of oscillating photons within a lasing medium is to provide planar reflective surfaces (mirrors) disposed in substantially parallel spaced relation to one another at opposite ends of the lasing medium. This arrangement is referred to as a Fabry-Perot resonator. The efficiency of the Fabry-Perot resonator is limited by the reflectivity of the reflective surfaces. In addition, Fabry Perot resonators produce multiple wavelengths corresponding to optical standing waves, or modes, determined by the geometry of the resonator.

Typically, WDM systems use distributed feedback (DFB) laser diodes as a light source. DFB laser diodes are also referred to as single longitudinal-mode laser (SLML) diodes. In a distributed feedback laser, a series of interfaces between regions of differing refractive index provide multiple opportunities to reflect passing photons. As will be understood by one of ordinary skill in the art, variations in the refractive index of the lasing material can be achieved by corresponding variations in material composition and/or variations in the boundary geometry of the lasing medium.

Light of a particular wavelength can be efficiently reflected when the distances between interfaces corresponds to a multiple of one quarter of the light's wavelength. As a result, DFB lasers can be arranged to efficiently generate and amplify light of a particular wavelength (i.e., a narrow band of wavelengths) while producing substantially no other wavelengths of light. This monochromatic light production is desirable in optical communications, because substantially monochromatic light is correspondingly free of chromatic dispersion when transmitted through an optical fiber.

Heating of the lasing medium causes thermal expansion, with a corresponding increase in distance between refractive index interfaces. Conversely, cooling of the medium causes thermal contraction of the lasing medium and a reduction in the distance between refractive index interfaces. Because the wavelength of light produced by a DFB laser is related to the spacing between the refractive index interfaces, the laser can be tuned (i.e., its color controlled) by controlling the temperature of the lasing medium.

The gain of the lasing medium is also related to the wavelength of light being amplified and the temperature of the lasing medium. As the temperature of the lasing medium changes, the wavelength of peak amplification also changes. In typical lasing media, gain decreases substantially monotonically with increasing temperature over an operational temperature range.

The power in a DFB laser's main spectral peak, also referred to as the “main mode” determines the power produced by the laser. Peak amplitude generally ranges from 10 mW to 50 mW and can be more. Ideally, the main spectral peak contains all the power produced by the laser. In a non-ideal laser, the laser signal includes side peaks, also referred to as “side modes,” that contain some power. A measure used to describe the amount of power in the main mode versus the amount of power in the side modes is the side-mode suppression ratio (SMSR). A DFB laser's SMSR describes the amplitude difference between the main mode and the largest side mode in decibels.

A typical SMSR value is greater than 30 dB, indicating that most of the power resides in the main mode. The more power residing in the main mode of the laser, generally the higher the SMSR value of the laser. Another measurement useful in the DFB laser is the mode offset which is the wavelength separation between the main mode and the largest side mode. This is typically 1 nm.

### SUMMARY

The inventors have discovered that it is advantageous to provide a laser device, including a lasing medium, a reflective portion and a heater device. The heater device is thermally coupled to the lasing medium and/or the reflective portion. The heater device is adapted to warm the lasing medium and/or the reflective portion when a temperature falls below a threshold value. A thermal gain characteristic of the lasing medium and/or a thermal characteristic of the reflective portion are selected to optimize operation of the laser device over a temperature range above the threshold value. Accordingly, in one embodiment of the present invention a lasing device is operated with temperature control over a first operational temperature interval and without temperature control over a second operational temperature interval.

In one embodiment, the heater device is adapted to bring the lasing medium and/or the reflective portion only to a lower operational threshold of the laser device. This is unlike the temperature stabilized lasers used in DWDM systems, which are maintained within a narrow band of temperatures about an operational optimum temperature by a temperature control system.

According to the present invention, it is anticipated that the laser device will operate over a relatively broad range of temperatures, as compared with a DWDM system, and the characteristics of the lasing medium and reflective portion respectively are optimized in anticipation of this change in thermal conditions.

Although thermal variation in the light wavelengths produced by CWDM lasers is typically not a significant concern when such lasers operate at room temperature of 25° C. Such thermal variation does it come a problem when DFB lasers are required to operate over a very wide temperature range such as, for example, −40° C. to 85° C.

Temperature changes affect DFB lasers, according to the invention, in three ways. First the material gain amplitude changes. The material gain decreases as temperature increases and increases when temperature decreases. Second, the material gain peak shifts towards the longer wavelengths as temperature increases with a temperature coefficient of about 1 nm/° C. Third, the grating reflection spectrum peaks shift towards longer wavelength as the temperature increases, with a temperature coefficient of about 0.1 nm/° C.

The International Telecommunication Union (ITU) specification for CWDM systems specifies that wavelength drift not exceed 13 nm. Conventional DFB lasers can, under ideal conditions, come close to meeting ITU specifications. Ideal conditions, however, are not always possible.

The problems of meeting ITU specification are solved by the present invention of a coarse wavelength division multiplexing (CWDM) optical transmission system, and a distributed feedback (DFB) laser that is tuned so that the peak reflection of the grating overlaps with the gain range of the DFB laser over a particular temperature range. The diffraction grating is tuned so that the reflectance spectrum peak is advantageously placed on the gain spectrum curve with regard to the gain at a specified temperature. When the peak reflection spectrum and the gain range spectrum coincide, laser output is maximized. The optical transmission system operates in an environment having a wide temperature range (i.e., −40° C. to 80° C.). At the low end of the temperature range, the grating peak and the gain range are separated. The grating peak and the gain range shift at different rates as temperature changes. As heat is applied and the laser temperature increases, the gain range overtakes the grating peak and the two spectra overlap. When the spectra overlap at increased laser temperature, laser output is improved over laser output at low temperatures. The optical transmission system of the present invention reduces the range of temperatures over which the laser operates and also reduces wavelength drift such that the system meets requirements of the CWDM standard as set out in ITU G.695.

In a coarse wavelength division multiplexing (CWDM) optical transmission system, a distributed feedback (DFB) laser is tuned so that the peak reflection of the grating overlaps with the gain range of the DFB laser. Specifically, the diffraction grating is tuned so that the peak is advantageously placed on the wavelength spectrum with regard to the gain at a specified temperature. When the peak reflection spectrum and the gain range spectrum coincide, laser output is maximized. The optical transmission system operates in an environment having a wide temperature range (i.e., −40° C. to 80° C.). At the low end of the temperature range, the grating peak and the gain range are separated.

The grating peak and the gain range shift at different rates as temperature changes. As heat is applied and the laser temperature increases, the gain range overtakes the grating peak and the two spectra overlap. When the spectra overlap, at increased laser temperature, laser output is improved over laser output at low temperatures. The optical transmission system of the present invention reduces the range of temperatures over which the laser operates and also reduces wavelength drift such that the system meets requirements of the CWDM standard as set out in ITU G.695.

The present invention together with the above and other advantages may best be understood from the following detailed description of the embodiments of the invention illustrated in the drawings, wherein:

### BRIEF DESCRIPTION OF THE DRAWINGS

FIG. 1 shows, in graphical frequency domain representation, a portion of an exemplary optical spectrum used for wavelength division multiplexing (WDM);

FIG. 2 shows, in cutaway perspective view, a portion of a distributed feedback laser device according to one embodiment of the invention;

FIG. 3 shows a graphical representation of gain and reflectance curves for a laser device according to one embodiment of the invention;

FIG. 4 shows a graphical representation of gain and reflectance curves in relation to temperature variation for a laser device according to one embodiment of the invention;

FIG. 5 shows a graphical representation of gain and reflectance curves for a laser device according to one embodiment of the invention;

FIG. 6 shows a graphical representation of gain and reflectance curves for a laser device according to one embodiment of the invention;

FIG. 7 shows a graphical representation of gain and reflectance curves for a laser device according to one embodiment of the invention;

FIG. 8 shows, in block diagram form, a laser device according to one embodiment of the invention;

FIG. 9 shows, in block diagram form, a laser device according to one embodiment of the invention;

FIG. 10 shows, in block diagram form, a laser device according to one embodiment of the invention;

FIG. 11 shows, in block diagram form, a laser device according to one embodiment of the invention;

FIG. 12 shows, in block diagram form, a laser device according to one embodiment of the invention;

FIG. 13 shows, in flow diagram form, a method of operating a laser device according to one embodiment of the invention; and

FIG. 14 shows, in block diagram form, and optical communication system including a laser device according to one embodiment of the invention.

### DETAILED DESCRIPTION

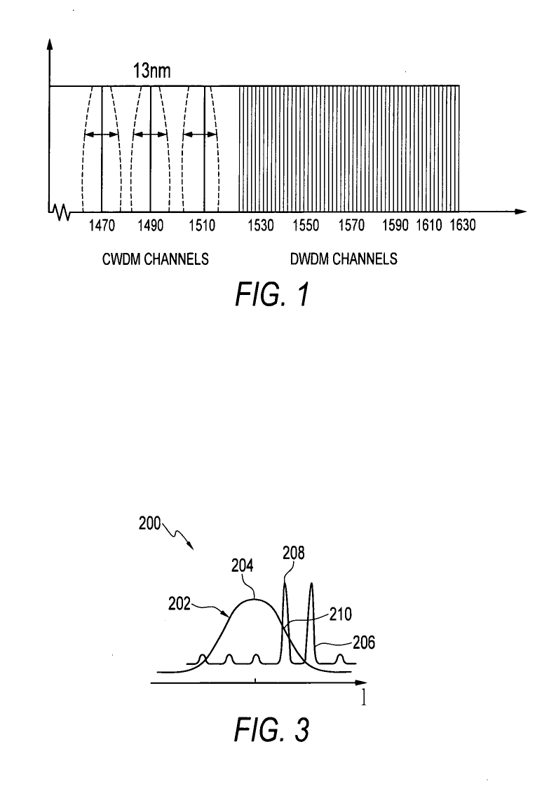

FIG. 1 shows, in graphical frequency domain form, CWDM and DWDM channels distributed across a wavelength spectrum. The difference in bandwidth usage between CWDM and DWDM is readily apparent. In the exemplary system of FIG. 1, the CWDM channels are spaced 20 nm apart to accommodate a drift of laser wavelengths. A maximum of 13 nm from peak to peak is desirable. CWDM in this example fits a maximum of eight channels in the wavelength range from 1470 nm to 1510 nm.

In DWDM, the channels are spaced approximately 0.8 nm apart. Temperature stabilization of the laser enables DWDM channels to be grouped closer together than in CWDM channels. For clarity of presentation, FIG. 1 shows approximately only one third of the DWDM channels possible in the wavelength range between approximately 1525 nm to 1630 nm.

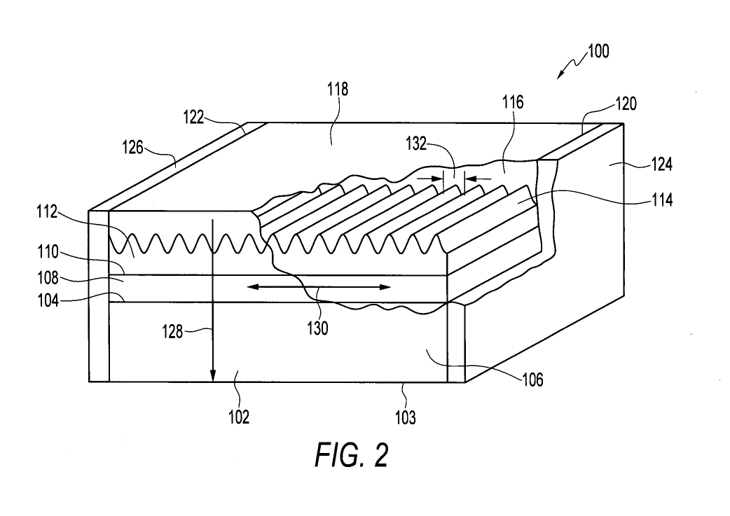

FIG. 2 shows, in cutaway perspective view, a portion of a dual heterojunction laser device 100 according to one embodiment of the invention. The device 100 includes a substrate region 102. According to various embodiments of the invention, the substrate region may be formed of any appropriate material including, for example, a semiconductor material such as gallium aluminum arsenide or indium gallium arsenide phosphide. The substrate region 102 includes a first lower surface 103.

According to one embodiment of the invention, a first junction 104 is disposed within the substrate region 102. The first junction 104 defines an interface between a first region 106 of substrate 102 having a first atomic doping characteristic and a second region 108 having a second atomic doping characteristic. According to one embodiment of the invention, the first junction 104 is disposed in a substantially planar arrangement. Also according to one embodiment of the invention, the first junction 104 is disposed in substantially planar spaced relation to the first surface 103.

A second junction 110 is disposed within the substrate 102 in substantially planar spaced relation with respect to the first junction 104. The second junction 110 is disposed between the second region 108 and a third region 112 of substrate 102. Like the first junction 104, the second junction 110 defines an interface between regions of different atomic doping characteristics. One of ordinary skill in the art will understand that the first and second junctions may be formed by, for example thermal diffusion and/or ion implantation. In addition, a doping profile may be selected for each junction according to the requirements of a particular application, and implemented according to the routine knowledge of one of skill in the art.

As shown in the illustrated embodiment, a further interface 114 of the substrate 102 defines a corrugated curve interface disposed in close proximity to, and generally parallel to, the second junction 110. According to one embodiment, this further corrugated curve interface 114 corresponds to an upper surface of the substrate 102. A further region 116 is disposed adjacent to the corrugated curve interface 114. According to one embodiment of the invention, the corrugated curve interface 114 includes a substantially periodic region so as to define length of periodicity (or wavelength) 132 of the corrugation.

According to various embodiments, this region 116 includes a further portion of the substrate 102. In one alternative embodiment, the region 116 includes an epitxial layer disposed adjacent to interface 114. According to one embodiment, region 116 includes an upper surface 118. Also, in one embodiment, upper surface 118 includes a substantially planar region disposed in substantially parallel space relation with respect to surface 103.

In one embodiment, the substrate material 102 includes a first end surface 120 and a second and surface 122. The first end surface 120 is disposed in substantially parallel space relation to second end surface 122, and both first and second and surfaces 120, 122 are disposed substantially perpendicular to junctions 104 and 110. According to one embodiment of the invention, a corresponding layer 124, 126 of material is disposed adjacent to surfaces 120, 122.

In various embodiments of the invention, surfaces 103 and 118 are switchingly coupled to respective sources of electrical potential so that an electrical current 128 can be caused to flow between surfaces 118 and 103 through the substrate material 102. Accordingly, various electrical terminals and or electrical connectors, such as, for example, metallic and/or semiconductor traces may be electrically coupled to surfaces 118 and 103 respectively.

In operation, region 108 of laser device 100 forms an active region for light emission and amplification. Electrical current 128 serves to pump a portion of the atoms of region 108 and place those atoms into an inversion state, whereupon those atoms are subject to stimulated emission of photons by interaction with other photons passing through the active region. The proximity of corrugated surface 114 to junction 110 causes a variation in optical index of refraction of region 108 periodically along a longitudinal axis 130. According to one embodiment of the invention, this variation in optical index of refraction varies periodically with a length of periodicity corresponding to the length of periodicity 132 of the corrugated interface 114. This periodic variation in index of refraction effects a reflection of photons of one or more selected frequencies along longitudinal axis 130. Repeated reflections (i.e., oscillation) of these photons provides an extended effective length of photon travel within region 108 so as to allow efficient stimulation of additional photon production, and amplification of light within region 108.

As would be understood by one of ordinary skill in the art, the gain characteristic of region 108 depends on a variety of factors including chemical and crystallographic characteristics of the material of substrate 102 within region 108. In addition, the gain of region 108 varies as a function of temperature and as a function of a wavelength of light passing through the region. In like fashion, as discussed above, optical reflectivity within region 108 varies as a function of the light passing through the region.

FIG. 3 shows, in graphical form, a representation 200 of optical gain and reflectivity within region 108. Curve 202 shows optical gain as a function of light wavelength. In various embodiment of the invention, curve 202 may take a variety of forms including the form of a normal bell curve. A maximum 204 of curve 202 corresponds to a light wavelength lambda zero of maximum gain.

Reflectance as a function of optical wavelength within region 108 is shown by a grating reflectance curve 206. The grating reflectance curve 206 varies as a function of optical wavelength and exhibits at least one local maximum 208. The stimulation of photons within the active region 208 proceeds as a function of gain and reflectance. Accordingly, where the gain curve 202 and reflectance curve 206 coincide to produce a maximum stimulation value 210 the production of stimulated photons is at a maximum. When this production of stimulated photons exceeds a lasing threshold, the device 100 begin producing laser light.

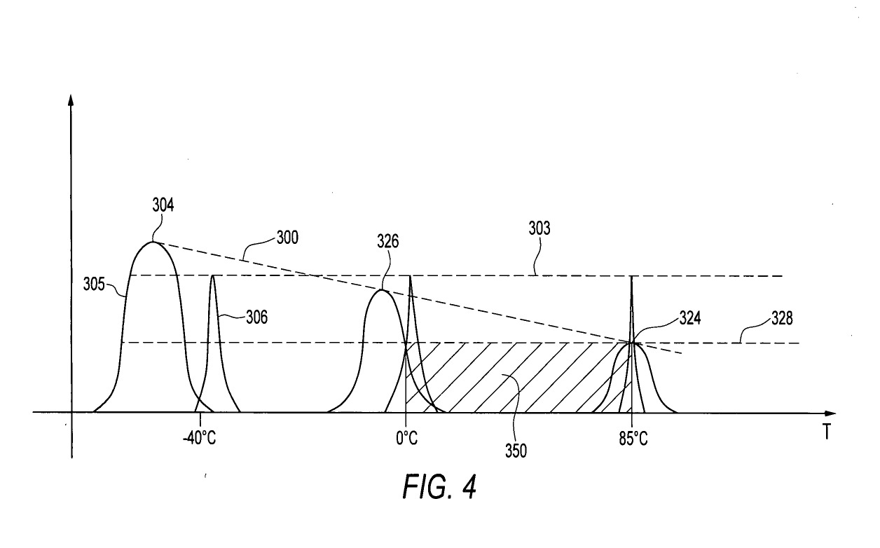

FIG. 4 shows, in graphical form, an optical gain curve 305 showing variation in optical gain of region 108 with respect to a variation in temperature of region 108. This variation is indicated by broken line 300. Also indicated is a relative variation in the relative distance between gain and reflectivity response peaks as a function of temperature.

As shown, according to one embodiment of the invention, a first value 304 of gain 302 is relatively high at a temperature of about −40° C. Optical gain 300 decreases substantially monotonically to a second lower value 324 at a temperature of about 85° C. At a temperature of about 0° C., optical gain 300 has an intermediate value 326. One of skill in the art will appreciate that the variation of gain 300 with temperature may be affected by a variety of factors that may be controlled by the designer. Accordingly, in various embodiments, curve 300 may be nonlinear and may be nonmonotonic.

In the illustrated embodiment, the peak value of reflectance curve 306 is shown as a function of temperature by broken line 303. In the illustrated embodiment, the reflectance is shown to be substantially linear and invariant with temperature. One of skill in the art will appreciate, however, that the reflectance 303 may exhibit other characteristics including linear and nonlinear variation with temperature.

Also shown in FIG. 4 is a broken line 328. Line 328 indicates a lasing threshold for a laser device according to an exemplary embodiment of the invention. As illustrated, the lasing threshold 328 is substantially linear and invariant with temperature. One of skill in the art will appreciate, however, that a variety of other lasing characteristics are possible within the scope of the present invention. The lasing characteristic line 328 indicates the threshold at which lasing will occur when the gain characteristic and reflectance characteristic of region 108 are each sufficiently high for a particular optical wavelength.

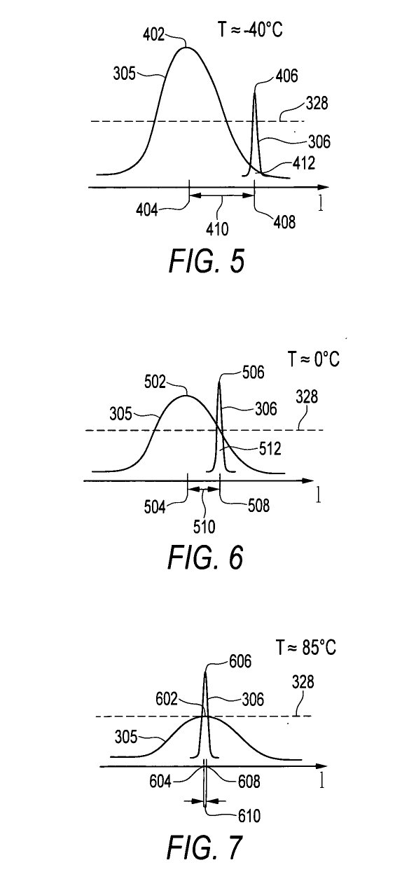

FIG. 5 shows a further illustration of a gain curve 305 and a reflectance curve 306, both shown with respect to wavelength, according to one embodiment of the invention. The curves of FIG. 4 are shown at a temperature of, for example, about −40° C. As illustrated, a maximum 402 of gain curve 305 occurs at a first wavelength 404. A maximum 406 of reflectance curve 306 occurs at a substantially different second wavelength 408. Because of a scalar difference 410 between these maxima 402, 404 a region of overlap 412 between the gain curve 305 and the reflectance curve 306 has a relatively small area, and a maximum of this coincident region is substantially below the lasing threshold 328. Accordingly, for an active region 108 (as shown in FIG. 1) having the characteristic curves shown in FIG. 4, lasing cannot be effectively and reliably achieved at about −40° C.

FIG. 6 shows another illustration of a gain curve 305 and a reflectance curve 306, both shown as a function of wavelength, according to one embodiment of the invention. The curves of FIG. 6 are shown at a temperature of, for example, about 0° C. At this temperature, the maximum 502 of gain curve 305 occurs at a third wavelength 504. The maximum 506 of reflectance curve 306 occurs at a fourth wavelength 508. Wavelength 504 is greater than wavelength 404, and wavelength 508 is greater than wavelength 408. Because gain varies more strongly as a function of temperature than reflectance, however, scalar difference 510 is smaller than scalar difference 410. The result is an increased overlap 512 between curves 305 and 306 at a temperature of about 0° C. as compared with the corresponding overlap 412 at a temperature of about −40° C., and a coincidence of curves 305 and 306 at approximately the lasing threshold 328. It should be noted that the increased overlap 512 and elevated coincidence of curves 305 and 306 occurs despite the fact that an absolute value of the gain maximum 502 (at about 0° C.) is less than the absolute gain maximum 402 (at about −40° C.).

FIG. 7 shows still another illustration of gain curve 305 and reflectance curve 306 as a function of wavelength according to one embodiment of the invention. The curves of FIG. 7 are shown at a temperature of, for example, about 85° C. At this temperature, the maximum 602 of gain curve 305 occurs at a fifth wavelength 604. The maximum 606 of reflectance curve 306 occurs at a sixth wavelength 608. It should be noted that wavelengths 604 and 608 are higher than wavelengths 504 and 508 respectively. As is apparent from FIG. 7, wavelengths 604 and 606 are, in this exemplary embodiment, substantially equal to one another at a temperature of about 85° C. Accordingly, a scalar difference 610 between wavelengths 604 and 608 is approximately 0. The result is that gain curve 305 and reflectance curve 306 overlap with an area 612, and coincide at a value substantially equal to the lasing threshold 328. This coincidence occurs despite the fact that maximum the 602 of gain curve 305 is again substantially lower than the maximum 502 of the gain curve, as exhibited at a temperature of approximately 0° C.

Referring again to FIG. 4, one sees that by proper selection of device characteristics, one of skill in the art can prepare a laser device adapted to produce light above the lasing threshold 328 between a temperature about 0° C. and about 85° C., for example. This is achieved by maintaining proper overlap of the gain curve 305 and reflectance curve 306 to produce a lasing result 350 within the indicated temperature range. Having recognized that proper selection of parameters could produce this result, the inventors have further discovered that improved lasing can be achieved by using a temperature control device to broaden the operative range of a laser device.

In one aspect, the invention provides wavelength stabilization of CWDM lasers. As noted above, conventional CWDM and DWDM channels are distributed across a wavelength spectrum. CWDM channels are typically spaced 20 nm apart to accommodate a drift of laser wavelengths. A maximum of 13 nm from peak to peak is desirable. CWDM, for example, fits a maximum of eight channels in the wavelength range from 1470 nm to 1510 nm. In DWDM, the channels are spaced approximately 0.8 nm apart. Conventionally, temperature stabilization of the laser enables DWDM channels to be grouped closer together than in CWDM.

According to one embodiment of the invention, the diffraction grating is tuned to produce a grating peak that overlaps the long wavelength end of the material gain range at 0° C. At temperatures below 0° C., the heating element 265 is activated and the temperature of the laser is raised to be close to 0° C. At temperatures above 0° C., the heating element is deactivated. Using this method, the temperature range of the laser in operation remains in the range approximately of about 0° C. to about 85° C. Thus, the material gain range shifts approximately only 85 nm and the laser stays within the DFB lasing range.

With a temperature coefficient of 0.1 nm/° C., the laser has a wavelength drift of 12.5 nm for a temperature range of 125° C. (−40 to 80° C.). The CWDM standard (ITU G.695) specifies a wavelength range of 13 nm. Without temperature control of the laser, it can be difficult to meet the CWDM standard. With temperature control, however, the laser can be readily operated within the CWDM standard.

If the laser chip temperature is increased by, for example, about 40° C. when the case temperature is at about −40° C., the total temperature range is reduced from about 125° C. to about 85° C. With the reduced temperature range, the laser wavelength drift is also reduced, from approximately 12.5 nm to approximately 8.5 nm. This enables a CWDM system including the temperature controlled laser to operate within ITU specifications.

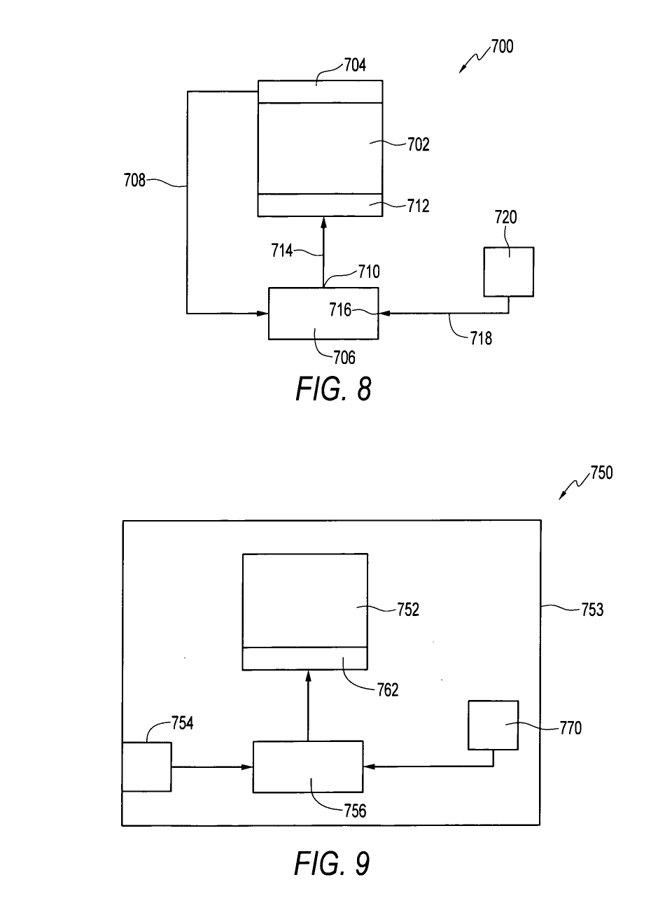

FIG. 8 shows, in block diagram form, a laser system 700 including a temperature control device according to one embodiment of the invention. The laser system 700 includes a laser device 702. According to one embodiment, the laser device includes a DFW laser device similar, for example, to that shown in FIG. 1. A temperature sensor device 704 is thermally coupled to the laser device 702. According to one embodiment of the invention, the temperature sensor device 704 is disposed directly adjacent to the laser device 702. In another embodiment of the invention, a thermally conductive medium such as, for example, a thermally conductive grease is disposed between the laser device 702 in the temperature sensor device 704.

The temperature sensor device 704 is signalingly coupled to a control device 706 by way of a signaling medium 708. According to one embodiment of the invention, the signaling medium 708 is an electrically conductive medium, such as, for example, a metallic trace. According to one embodiment of the invention, the signaling medium 708 is electrically coupled to the temperature sensor device 704 and to a signal input of the temperature control device 706.

According to one embodiment of the invention, the temperature control device 706 includes a control output 710 that is coupled to a corresponding input of a heater device 712 by means of, for example, an electrical conductor 714. The temperature control device 706 also includes a power input 716. The power input 716 is electrically coupled through a power conductor 718 to a source of heater power 720.

According to one embodiment of the invention, the heater device 712 is thermally coupled to the laser device 702. In one embodiment of the invention, the heater device 712 is integrally formed with the heater device 702. In another embodiment of the invention, the heater device 712 includes a discrete heater device that is disposed adjacent to the laser device 702.

In operation, the temperature sensor device 704 detects a temperature of the laser device 702. Responsive to this detected temperature, the temperature sensor device 704 dispatches a signal over the signaling medium 708 to the temperature control device 706. The temperature control device 706 receives the signal and, depending on a state of the signal, controls a state of output 710. In a first state, output 710 transfers power, such as electrical power received from power supply 720, to heater device 712 thereby activating, or leaving active, heater device 712. In a second state, output 710 does not transfer power to heater device 712, thereby deactivating, or leaving inactive, heater device 712.

According to one embodiment of the invention, the control device 706 activates the heater device 712 when a temperature detected by the temperature sensor device 704 is equal to or less than a threshold temperature. According to one embodiment of the invention, the threshold temperature is approximately 0° C. In one embodiment of the invention, activation of the heater device is adapted to raise a temperature of the laser device 702 from a first temperature of about −40° C. to a second temperature of about 0° C.

FIG. 9 shows, in block diagram form, a further embodiment of the invention including a laser device 752 disposed within a case 753. According to one embodiment of the invention, a heater device 762 is thermally coupled to the laser device 752. According to one embodiment, a control device 756 is disposed within the case 753 and is operatively coupled to the heating device 762 to control a heating state of the heating device. In one aspect of the illustrated embodiment, a temperature sensor device 754 is thermally coupled to the case 753 to detect a temperature of the case.

According to one embodiment of the invention, the temperature sensor device 754 is operatively coupled to the temperature control device 756 to control an operative state of the temperature control device 756. In one embodiment, a power supply 770 is disposed within the case 753. In another embodiment of the invention, the case 753 includes an integrated circuit device, and both the laser device 752 and the temperature sensor device 762 are mutually formed on a common integrated circuit device substrate. In still another embodiment of the invention, the laser device 752, the heater device 762, the temperature control device 756, and the temperature sensor device 754 are all usually formed on a common integrated circuit device substrate. In still another embodiment of the invention, the temperature sensor device 754, and the control device 756 are mutually formed on a common substrate of an integrated circuit device which is operatively coupled to a discretely formed laser device 752.

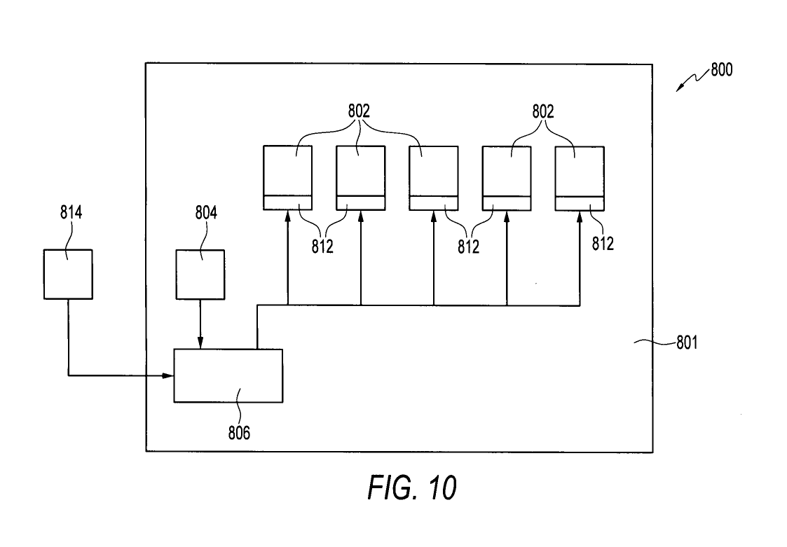

FIG. 10 shows another embodiment of the invention 800 in which a plurality of laser devices 802 are mutually formed on a common integrated circuit substrate 801. According to the illustrated embodiment, a respective plurality of heater devices 812 are also mutually formed on the common integrated circuit substrate 801, along with a single sensor device 804 and a single temperature control device 806. According to one embodiment of the invention, each heater device of the plurality of heater devices 812 is maintained in a common operative state by single temperature control device 806. The operative state of the single temperature control device is, for example, controlled by the single sensor device 804. The single sensor device 804 is adapted to sense a temperature of, for example, the common integrated circuit substrate 801.

According to one aspect of the invention, when a temperature of the substrate 801 falls below a threshold temperature such as, for example, about 0° C., every heater of the plurality of heaters 812 is activated. In one embodiment of the invention, power for the plurality of heaters 812 is applied by an external power supply 814.

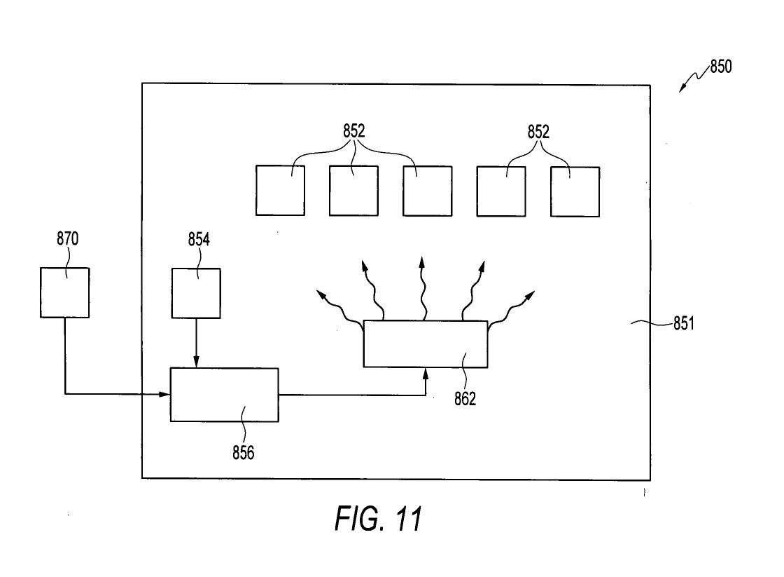

FIG. 11 shows still another embodiment of the invention. According to the arrangement 850 of FIG. 11, a plurality of laser devices 852 is disposed on a common substrate 851 such as, for example, an integrated circuit device substrate. Also mutually disposed on the common substrate is a temperature sensor device 854 and a temperature control device 856, as well as a common heater device 852. The common heater device 852 is thermally coupled to two or more of the plurality of laser devices 852.

When activated, the common heater device 862 is adapted to elevate a temperature of the two or more of the plurality of laser devices 852. According to one embodiment of the invention, the common heater device 862 is thermally coupled to the two or more laser devices 852 by conductive heating through, for example, the common substrate 851. In another embodiment of the invention, the common heater device 862 is thermally coupled to the two or more laser devices 852 by, e.g., thermal radiation received by the two or more laser devices 852. In still another embodiment of the invention, the common heater device 862 is thermally coupled to the plurality of laser devices by convective heating through, for example, a fluid medium such as a gas, or a liquid. According to one embodiment of the invention, power to activate the heating device 862 is supplied by an external power supply 870.

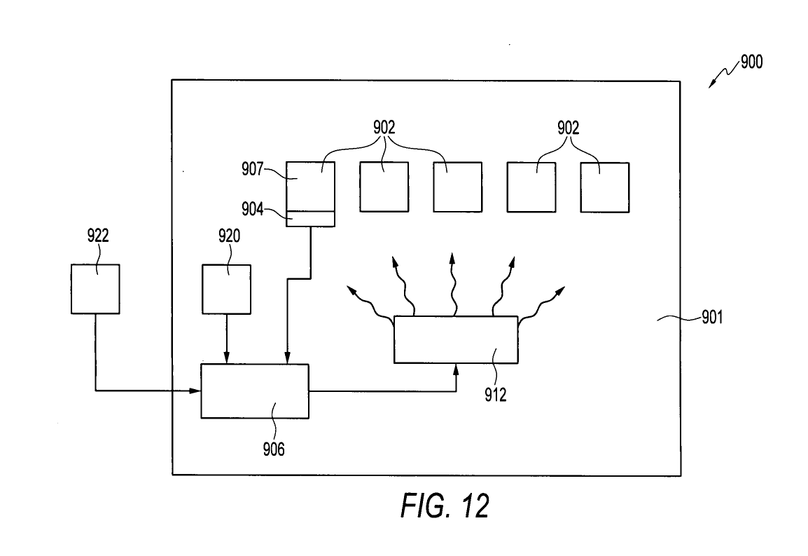

FIG. 12 shows another embodiment of the invention 900 in which a plurality of laser devices 902 are mutually disposed on a common integrated circuit substrate 901. A common heater device 912 is also mutually disposed on the common integrated circuit substrate 901, along with a temperature control device 906. According to one embodiment of the invention, a temperature sensor device 904 is thermally coupled to one (e.g., 907) of the plurality of laser devices 902. The temperature sensor device 904 is signalingly coupled to the temperature control device 906, which is in turn operatively coupled to the heater device 912. According to one aspect of the invention, the temperature control device 906 controls an activation state of the heater device 912 according to a localized temperature of the one laser device 907 as detected by the temperature sensor device 904. The heater device 912 is mutually thermally coupled to two or more of the plurality of laser devices 902. Accordingly, a temperature of two or more of the plurality of laser devices 902 is controlled according to a temperature detected at one of the plurality of laser devices 902.

In another embodiment of the invention, the temperature control device 906 receives a temperature control signal from a plurality of temperature sensor devices. For example, in one embodiment of the invention, the temperature control device 906 receives a first temperature signal from a first temperature sensor device thermally coupled to a laser device 902, and a second temperature signal from a second temperature sensor device 920 thermally coupled to substrate 901. According to one embodiment of the invention, power to activate the temperature sensor device 906 and/or the heater device 912 is received from an external power supply 922.

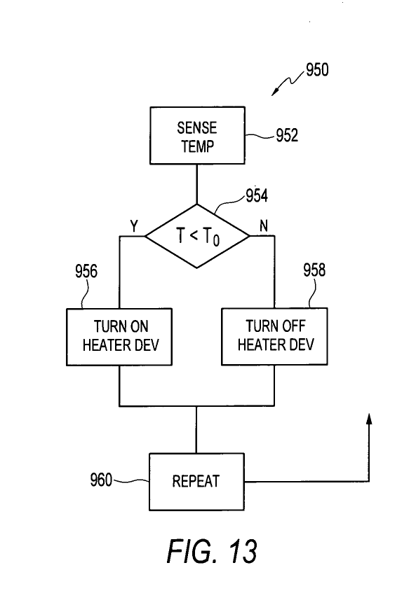

FIG. 13 shows, in flow diagram form, a method 950 for operating a temperature control device for a laser device according to one embodiment of the invention. As illustrated, the method includes detecting a temperature 952. Based on a value of the detected temperature, a decision 954 is made. If the detected temperature is less than a threshold temperature, such as for example 0° C., then a heater device is activated 956 (or left activated). If the detected temperature is greater than the threshold temperature, then the heater device is not activated 958 (or deactivated). Thereafter, either instantaneously or at some time interval, the process is repeated 960 beginning with detecting a temperature 952.

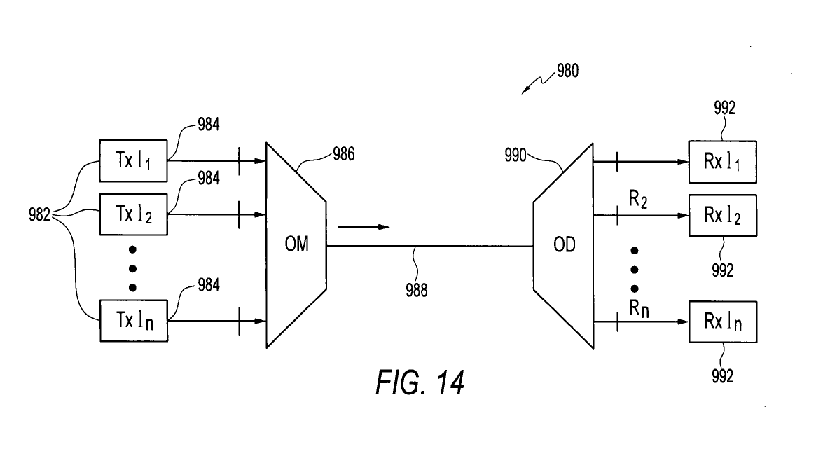

FIG. 14 shows, in block diagram form, a portion of an exemplary telecommunication system 980 according to one embodiment of the present invention. The telecommunication system 980 includes a plurality of transmitter devices 982 having a respective plurality of optical outputs 984. Each of the plurality of optical outputs 984 is signalingly coupled to a respective input of an optical multiplexer 986. An output of the optical multiplexer 986 is coupled to an input of a communication medium such as, for example, an optical fiber 988. An output of the optical fiber 988 is coupled to an input of an optical demultiplexer 990. A plurality of outputs of the optical demultiplexer 990 are coupled to respective inputs of the respective plurality of receiver devices 992. At least one of the plurality of receiver devices 992 is adapted to operate under temperature control over a first operative temperature range, and adapted to operate without temperature control over a second operative temperature range. In one exemplary embodiment, at least one of the plurality of receiver devices 992 includes a receiver device as illustrated in one or more of FIGS. 1-13 of the present application.

While the invention has been described in detail in connection with the exemplary embodiments, it should be understood that the invention is not limited to the above disclosed embodiment. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

1. A method of operating a CWDM laser device comprising:
heating said CWDM laser over a first temperature range; and
operating said CWDM laser device without temperature control over a second operating temperature range so as to maintain said operating CWDM laser device within said second temperature range and thereby stabilizing an output wavelength of said CWDM laser device.

2. A method of operating a CWDM laser device as defined in claim 1 wherein a lowest temperature of said second operating temperature range exceeds a highest temperature of said first temperature range.

3. A method of operating a CWDM laser device as defined in claim 1 wherein said semiconductor laser device is illuminated when said CWDM laser device has a temperature within said second operating temperature range and said CWDM laser device is extinguished when said CWDM laser device has a temperature within said first temperature range.

4. A method of operating a semiconductor laser device as defined in claim 1 wherein said first temperature range comprises a temperature range from about −40° C. to about 0° C.

5. A method of operating a semiconductor laser device as defined in claim 1 wherein said second operating temperature range comprises a range from about 0° C. to about 85° C.
